(19) United States
(12) Patent Application Publication
(10) Pub. No.: US 2011/0265712 A1
(43) Pub. Date: Nov. 3, 2011

(54) METERING ROD FOR METERING SYSTEMS FOR DISPERSING AND WIPING OFF A LIQUID OR VISCOUS MEDIUM ON MOVING MATERIAL WEBS

(75) Inventors: MICHAEL HAGEDORN, Oer-Erkenschwick (DE); HEIKO DODT, Hemer (DE)

(73) Assignee: Salzgitter Mannesmann Prazisrohr GmbH, Hamm (DE)

(21) Appl. No.: 12/910,135

(22) Filed: Oct. 22, 2010

(30) Foreign Application Priority Data
Oct. 23, 2009 (DE) 10 2009 050 917.8

(51) Int. Cl. B05C 11/02; D21H 25/12

(52) U.S. Cl. 118/118

(57) ABSTRACT

A metering rod for a metering system is disclosed for dispersing and wiping off a liquid or viscous medium applied in excess on a moving material web for coating to a desired coat weight. The metering rod includes a cold-drawn tube which is provided with at least one lip formed axis-parallel on an outer circumference of the tube.

### CROSS-REFERENCES TO RELATED APPLICATIONS

This application claims the priority of German Patent Application, Ser. No. 10 2009 050 917.8, filed Oct. 23, 2009, pursuant to 35 U.S.C. 119(a)-(d), the content of which is incorporated herein by reference in its entirety as if fully set forth herein.

### BACKGROUND OF THE INVENTION

The present invention relates to a metering rod for a metering system for dispersing and wiping off a liquid or viscous medium applied in excess on a moving material web for coating to a desired coat weight.

The following discussion of related art is provided to assist the reader in understanding the advantages of the invention, and is not to be construed as an admission that this related art is prior art to this invention.

The paper and cardboard industry uses pressure elements to apply pressure against fast moving paper and cardboard webs and at the same time to evenly disperse dyes to be applied over the cardboards and to wipe excess off. An example is disclosed in U.S. Pat. No. 5,599,392.

A problem associated with conventional coating applicators relates to wear which is especially prevalent when fast moving machines are involved. In addition, conventional coating applicators are not universally applicable.

It would therefore be desirable and advantageous to address prior art shortcomings and provide an improved coating applicator that has long service life, even when fast moving pressure-exerting machines are involved, and results in a reduction in operating expenses to thereby enhance efficiency.

### SUMMARY OF THE INVENTION

According to one aspect of the present invention, a metering rod for a metering system for dispersing and wiping off a liquid or viscous medium applied in excess on a moving material web for coating to a desired coat weight includes a cold-drawn tube provided with at least one lip formed axis-parallel on an outer circumference of the tube.

According to another advantageous feature of the present invention, the tube may be made of steel. Steel is a material that is more wear-resistant than, e.g. plastic, and permits the operation of the metering rod at higher operating speeds and operating temperatures. The tube may have an inner diameter of substantially circular configuration. As an alternative, the tube may have an inner diameter configured substantially in correspondence to an outer profile of the tube.

According to another advantageous feature of the present invention, the lip has a thickness which may gradually increase from the outer circumference of the tube to a tear-off edge configured to substantially extend radially toward the outer circumference of the tube. As a result, the lip receives a fin-like configuration with an incline that starts directly on the outer circumference of the tube and ends at the steeply sloped tear-off edge

According to another advantageous feature of the present invention, the outer circumference of the tube may be provided with two or more lips to reduce manufacturing and operating costs and increase service life of the tube by the number of attached lips. Suitably, the tear-off edge of one of the lips is disposed on the outer circumference in opposing relationship to the tear-off edge of the other one of the lips. The lips can be arranged on the tube in symmetric or asymmetric relationship. The number of lips may be selected in dependence on a moving speed of the material web and on a coating thickness being applied onto the material web.

According to another advantageous feature of the present invention, a high-strength friction-reducing coat may be applied on a surface of the lip. The coat may be made of a diamond-like carbon (DLC) coating based on carbon, or made of TiN, TiAIN, TiC, or MnS.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a schematic illustration of a first embodiment of a metering rod according to the present invention;

FIG. 2 is a schematic illustration of a second embodiment of a metering rod according to the present invention; and

FIG. 3 is a schematic illustration of a third embodiment of a metering rod according to the present invention.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. For example, even though the figures illustrate metering rods of circular configuration, any cross sectional geometries are, of course, possible as well in order to suit the application at hand. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

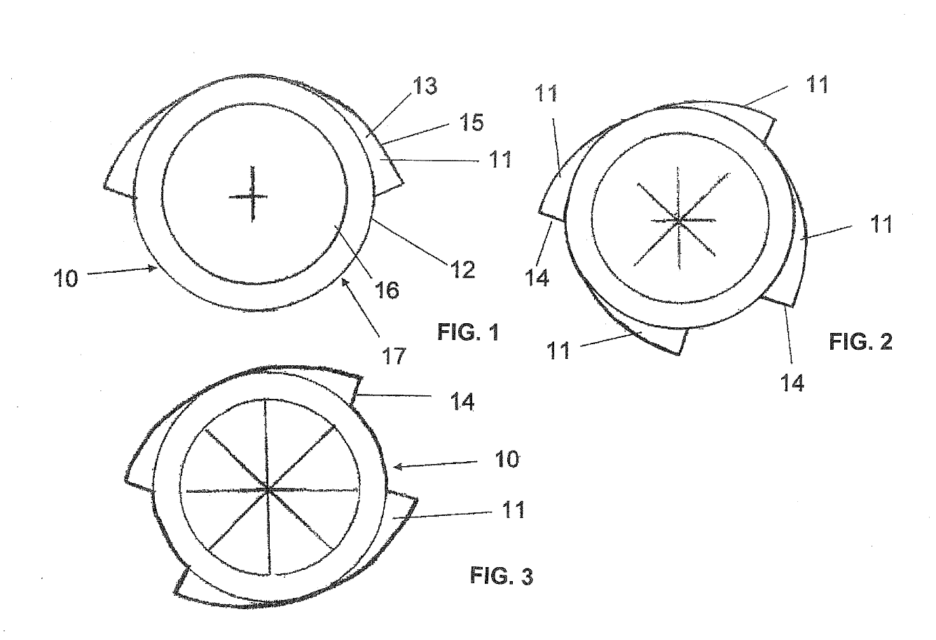

Turning now to the drawing, and in particular to FIG. 1, there is shown a schematic illustration of a first embodiment of a metering rod according to the present invention, including a cold-drawn profile tube 10 which is made of steel. The tube 10 has an outer circumference 12 formed with two lips 11 in opposite disposition. The lips 11 have each a fin-like configuration with a fairly flat incline 13 and a relatively steeply sloping tear-off edge 14. The tube 10 has an inner diameter 16 which is either round or approximates the configuration of the outer profile 17.

A coat 15 may be applied on the lips 11. Suitably, the coat 15 is of high strength and minimizes friction when interacting with fast moving paper and cardboard webs onto which liquid or viscous media are being applied. The coat 15 may be made of a diamond-like carbon (DLC) coating, which, optionally, may have a polished surface. DLC is a high-strength, wear-resistant and low-friction coating based on carbon so that the capacity of resistance to wear is increased and costs are reduced.

In general, the use of an uncoated tube is, of course, also possible, as is the application of a coating based on a different material, such as, e.g. TIN, TiAIN, TiC, or MnS.

FIG. 2 shows a schematic illustration of a second embodiment of a metering rod according to the present invention. Parts corresponding with those in FIG. 1 are denoted by identical reference numerals and not explained again. The description below will center on the differences between the embodiments. In this embodiment, provision is made for a tube 10 having four lips 11 on the outer circumference, with the tear-off edges 14 of two lips 11 confronting one another at a distance to each other.

FIG. 3 shows a schematic illustration of a third embodiment of a metering rod according to the present invention. Parts corresponding with those in FIG. 1 are again denoted by identical reference numerals and not explained again. The description below will center on the differences between the embodiments. In this embodiment, provision is made for a tube 10 having four lips 11 arranged on the outer circumference in asymmetric relationship. A benefit of such a construction is a swirl-reduction of the tube 10 during manufacture.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein: What is claimed is:

1. A metering rod for a metering system for dispersing and wiping off a liquid or viscous medium applied in excess on a moving material web for coating to a desired coat weight, said metering rod comprising a cold-drawn tube provided with at least one lip formed axis-parallel on an outer circumference of the tube.

2. The metering rod of claim 1, wherein the lip has a thickness which gradually increases from the outer circumference of the tube to a tear-off edge configured to substantially extend radially toward the outer circumference of the tube.

3. The metering rod of claim 1, wherein the outer circumference of the tube is provided with two of said lip, with the tear-off edge of one of said lips disposed in opposing relationship to the tear-off edge of the other one of said lips on the outer circumference.

4. The metering rod of claim 1, wherein the outer circumference of the tube is provided with four of said lip in spaced-apart relationship, with two tear-off edges of the lips respectively opposing one another.

5. The metering rod of claim 3, wherein the lips are arranged on the tube in symmetric relationship.

6. The metering rod of claim 4, wherein the lips are arranged on the tube in symmetric relationship.

7. The metering rod of claim 3, wherein the lips are arranged on the tube in asymmetric relationship.

8. The metering rod of claim 4, wherein the lips are arranged on the tube in asymmetric relationship.

9. The metering rod of claim 1, further comprising a high-strength friction-reducing coat applied on a surface of the lip.

10. The metering rod of claim 9, wherein the coat is a diamond-like carbon (DLC) coating based on carbon.

11. The metering rod of claim 9, wherein the coat is made of a material selected from the group consisting of TIN, TiAIN, and TiC.

12. The metering rod of claim 9, wherein the coat is made of MnS.

13. The metering rod of claim 1, wherein the outer circumference is provided with a number of said lip selected in dependence on a moving speed of the material web and in dependence on a coating thickness being applied onto the material web.

14. The metering rod of claim 1, wherein the tube has an inner diameter of substantially circular configuration.

15. The metering rod of claim 1, wherein the tube has an inner diameter configured substantially in correspondence to an outer profile of the tube.

16. The metering rod of claim 1, wherein the tube is made of steel.

17. The metering rod of claim 1, wherein the material web is a paper web or a cardboard web.
